(19) United States
(12) Patent Application Publication
(10) Pub. No.: US 2023/0265574 A1
(43) Pub. Date: Aug. 24, 2023

(54) METHOD FOR RECOVERING METALS FROM TUNGSTEN-CONTAINING METALLIC MATERIAL

(71) Applicant: National Tsing Hua University, Hsinchu City (TW)

(72) Inventors: Chih-Huang LAI, Hsinchu City (TW); Shao-Chi LO, Hsinchu City (TW); Tzu-Min CHENG, Tainan City (TW)

(21) Appl. No.: 17/859,278

(22) Filed: Jul. 7, 2022

(30) Foreign Application Priority Data
Feb. 18, 2022 (TW) 111105961

(51) Int. Cl. C25C 1/06; C22B 34/36

(52) U.S. Cl. CPC C25C 1/06; C22B 34/36

(57) ABSTRACT

A method for recovering metals from tungsten-containing metallic materials includes the steps of: providing a cathode and the tungsten-containing metallic material as an anode in an electrolyte solution which has a neutral, acidic or basic pH value; and subjecting the tungsten-containing metallic material to an electrolysis process under a power density that is greater than 3 W/cm² on the anode so that a passivation layer formed on the anode during the electrolysis process is broken down to permit the tungsten-containing metallic material to be continuously dissolved and oxidized, and a tungsten-containing compound is formed in the electrolyte solution.

### CROSS-REFERENCE TO RELATED APPLICATION

This application claims priority of Taiwanese Invention Patent Application No. 111105961, filed on Feb. 18, 2022.

### FIELD

The present disclosure relates to a method for recovering metals, and more particularly to a method for recovering metals from tungsten-containing metallic material.

### BACKGROUND

A tungsten-containing metallic material possessing characteristics such as high density, high hardness, high melting point, high boiling point, etc., is widely applied in various fields, for example, machinery, military, aviation, etc. Among the tungsten-containing metallic material, cemented tungsten carbide generally consisting of tungsten carbide matrix with cobalt as binder metal, is widely used for making mechanical components such as cutting tools, wear-resistant appliances, etc., and accounts for more than half of tungsten-containing metallic resources worldwide. Therefore, recovery of metals from the tungsten-containing metallic material such as cemented tungsten carbide becomes an important research focus for those skilled in the art.

The conventional methods employed in the industry for recovering metals from a tungsten-containing metallic material include mechanical crushing process, pyrometallurgy, hydrometallurgy, and electrolysis process. Among such methods, the electrolysis process has advantages such as high efficiency, high purity of metals thus recovered, and low solvent consumption. To be specific, in the method for recovering metals from a cemented tungsten carbide by the electrolysis process, the cemented tungsten carbide serving as an anode is placed in an electrolyte solution for electro-dissolution, so that a cobalt element serving as a binding metal of the cemented tungsten carbide is deposited on the cathode, and a tungsten element or tungsten carbide that dissolves from the anode and then precipitates from the electrolyte solution is obtained. However, during the electrolysis process, a passivation layer easily forms on the surface of the anode, causing a decreased efficiency in metal recovery, and low purity of the thus recovered metals (i.e., cobalt element, tungsten element and/or tungsten carbide).

### SUMMARY

Therefore, an object of the present disclosure is to provide a method for recovering metals from tungsten-containing metallic materials which can alleviate at least one of the drawbacks of the prior art.

According to the present disclosure, the method includes the steps of:

providing a cathode and the tungsten-containing metallic material serving as an anode in an electrolyte solution which has a pH value of one of neutral, not greater than 2, and not less than 10; and subjecting the tungsten-containing metallic material to an electrolysis process under a power density that is greater than 3 W/cm² on the anode so that a passivation layer formed on the anode during the electrolysis process is broken down to permit the tungsten-containing metallic material to be continuously dissolved and oxidized, and a tungsten-containing compound is formed in the electrolyte solution.

### BRIEF DESCRIPTION OF THE DRAWINGS

Other features and advantages of the present disclosure will become apparent in the following detailed description of the embodiments with reference to the accompanying drawings, of which:

FIG. 1 is a flow chart illustrating the steps in an embodiment of a method for recovering metals from tungsten-containing metallic materials according to the present disclosure; and

FIG. 2 is a schematic view illustrating components applied in an electrolysis process of the embodiment of the method according to the present disclosure.

### DETAILED DESCRIPTION

It is to be understood that, if any prior art publication is referred to herein, such reference does not constitute an admission that the publication forms a part of the common general knowledge in the art, in Taiwan or any other country.

For the purpose of this specification, it will be clearly understood that the word “comprising” means “including but not limited to”, and that the word “comprises” has a corresponding meaning.

Unless otherwise defined, all technical and scientific terms used herein have the meaning commonly understood by a person skilled in the art to which this disclosure belongs. One skilled in the art will recognize many methods and materials similar or equivalent to those described herein, which could be used in the practice of this disclosure. Indeed, this disclosure is in no way limited to the methods and materials described.

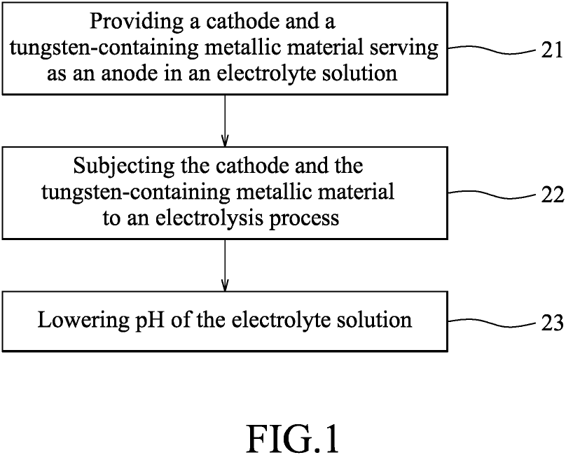

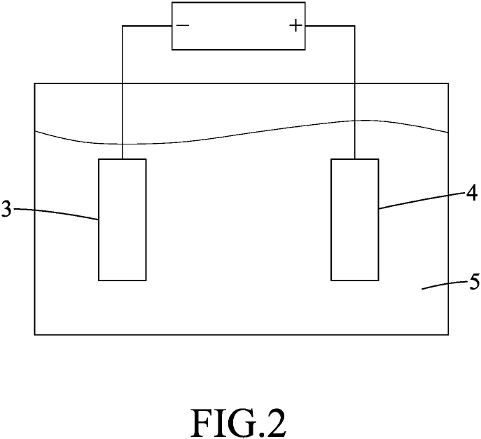

Referring to FIGS. 1 and 2, an embodiment of a method for recovering metals from tungsten-containing metallic materials according to the present disclosure includes steps 21 and 22.

In step 21, a cathode 3 and a tungsten-containing metallic material serving as an anode 4 which are immersed in an electrolyte solution 5 are provided.

The cathode 3 may be pure tungsten metal or an inert metal.

The tungsten-containing metallic material may be a tungsten-containing waste material which is to be subjected to a recycling process. Example of the tungsten-containing metallic materials may include, but are not limited to, cemented tungsten carbide (e.g., tungsten carbide cemented with cobalt), tungsten lanthanum alloy, a doped tungsten (e.g., doped with other metal elements or impurities in trace amounts), and combinations thereof. In this embodiment, the tungsten-containing metallic material may be in a form of a metal rod which is directly connected to a power supply as shown in FIG. 2. Alternatively, the tungsten-containing metallic material having different shapes may be placed in an electrolysis tank (not shown in the figure) that is electrically connected to the power supply, as long as the electrical power from the power supply passes through the tungsten-containing metallic material (serving as the anode 4) during an electrolysis process (described hereinafter). The configuration of the anode 4 is not limited to those disclosed herein.

The electrolyte solution 5 has a pH value that is controlled to be in the acidic, neutral or basic pH ranges. For example, the electrolyte solution 5 may have a neutral pH (e.g., 7), an acidic pH of not greater than 2, or a basic pH of not less than 10. The electrolyte solution 5 is prepared by dissolving a suitable electrolyte selected from an inorganic acid, a neutral electrolyte, and an inorganic base in a solvent (e.g., deionized water), depending on the pH range to be obtained. In a case of the acidic pH of not greater than 2, the electrolyte solution 5 is prepared using the acidic electrolyte which may include an inorganic acid selected from the group consisting of hydrochloric acid, sulfuric acid, nitric acid, perchloric acid, and combinations thereof. In a case of the basic pH of not less than 10, the electrolyte solution 5 is prepared using the basic electrolyte which may include an inorganic base selected from the group consisting of sodium carbonate, potassium carbonate, potassium hydroxide, and combinations thereof. In a case of the neutral pH, the neutral electrolyte for preparing the electrolyte solution 5 may include a supporting electrolyte selected from the group consisting of sodium chloride, potassium chloride, potassium sulfate, and combinations thereof. In an exemplary embodiment, the electrolyte solution 5 is prepared using hydrochloric acid.

In step 22, the tungsten-containing metallic material is subjected to the electrolysis process. For example, a voltage is applied to the tungsten-containing metallic material (i.e., the anode 4) to perform electro-dissolution. The electrolysis process is conducted at a temperature that is maintained below a boiling point of the electrolyte solution 5. In certain embodiments, the electrolysis process is conducted at a temperature ranging from 60° C. to 80° C. It should be noted that when the electrolysis process is conducted at a temperature of greater than 80° C., the solvent of the electrolyte solution 5 may be prone to be boiled and evaporated, resulting in loss of the solvent and change in concentration of the electrolyte solution 5. When the electrolysis process is conducted at a temperature of lower than 60° C., a reaction rate of the electrolysis process will be too slow, and heat will be generated and accumulated (particularly when a high voltage or high current is applied to achieve a desired power density range), causing difficulty in maintaining a stable reaction temperature.

As used herein, the term “electrolysis process” can be used interchangeably with other terms such as “electrometallurgy process”, “electrochemistry process”, etc.

Since the electro-dissolution of the electrolysis process would generate a passivation layer (i.e., a metal oxide layer) on the surface of the anode 4 (i.e., tungsten-containing metallic material) which would adversely affect the electrolysis process, the electrolysis process of step 22 is required to be conducted under a power density that is greater than 3 W/cm² on the anode 4 so that the passivation layer formed on the surface of the anode 4 during the electrolysis process is broken down to permit the tungsten-containing metallic material to be continuously dissolved and oxidized, and a tungsten-containing compound is formed in the electrolyte solution 5.

It should be noted that when the power density is less than 3 W/cm², the passivation layer formed on the surface of the metallic material during the electrolysis process may not be sufficiently broken down, and thus a contact area of the metallic material not covered by the passivation layer with the electrolyte solution 5 would be decreased as increased time period of the electrolysis process, resulting in a dissolution rate of the tungsten-containing metallic material being gradually decreased.

In addition, the reaction rate of the electrolysis process may be increased by increasing the power density on the tungsten-containing metallic material, so that the tungsten-containing compound thus formed will have a higher purity. In certain embodiments, during the electrolysis process, the power density on the anode 4 is controlled within a range of 3 W/cm² to 35 W/cm². For example, the power density on the anode 4 may be 3.5 W/cm², 7 W/cm², 13 W/cm², 27 W/cm², 28 W/cm² or 34 W/cm², or may range from 3.5 W/cm² to 34.5 W/cm², from 27 W/cm² to 34.5 W/cm², or from 27.6 W/cm² to 34.5 W/cm².

To be specific, when the power density on the anode 4 is controlled to be greater than 3 W/cm² during the electrolysis process, the energy thus generated is sufficient to break down the passivation layer formed on the surface of the anode 4, so that the tungsten-containing metallic material which was originally covered by the passivation layer can be therefore exposed to be continuously dissolved and oxidized.

In certain embodiments, the anode 4 is dissolved in a dissolution rate of not less than 13 mg/min during the electrolysis process.

It should be noted that the oxidation state of the tungsten-containing compound depends on the pH value of the electrolyte solution 5. For example, when the pH value of the electrolyte solution 5 in step 21 is one of neutral and not greater than 2, the tungsten-containing compound formed during the electrolysis process may include tungsten oxide that precipitates from the electrolyte solution 5.

When the pH value of the electrolyte solution 5 in step 21 is not less than 10, the tungsten-containing compound formed during the electrolysis process may include tungstate that dissolves in the electrolyte solution 5. In such case, the method may further include, after the electrolysis process, the step of lowering the pH of the basic electrolyte solution 5 (i.e., step 23) to convert tungstate to tungsten oxide that precipitates from the electrolyte solution 5. Step 23 may be conducted by adding an acidic electrolyte substance (e.g., an inorganic acid) into the electrolyte solution 5.

In an exemplary embodiment, in step 21, the tungsten-containing metallic material applied is cemented tungsten carbide including tungsten and cobalt, and the pH value of the electrolyte solution 5 is one of neutral and not greater than 2 (i.e., acidic or neutral environment); and in step 22, during the electrolysis process, the anode 4 is dissolved in a dissolution rate of not less than 15 mg/min to produce tungsten oxide in a hydrated form having a purity of not lower than 90%, and cobalt is electrodeposited onto the cathode 3. In such case, the tungsten oxide in the hydrated form (WO₃·nH₂O) that precipitated from the acidic or neutral electrolyte solution 5 may be collected by, e.g., the filtration process, and then the remaining cobalt ions dissolved in the electrolyte solution 5 (i.e., those not being reduced to form cobalt electrodeposited onto the cathode 3) may be converted to cobalt oxide by adding an alkaline electrolyte substance or a precipitant (e.g., oxalic acid) into the electrolyte solution 5. Alternatively, conversion of cobalt ions to cobalt metal precipitating from the electrolyte solution 5 may be performed through electroplating process by further applying a direct current to the electrolyte solution 5.

In another exemplary embodiment, in step 21, the tungsten-containing metallic material provided is cemented tungsten carbide including tungsten and cobalt, and the pH value of the electrolyte solution 5 is not less than 10 (i.e., basic environment); and in step 22, during the electrolysis process, the thus formed tungsten-containing compound includes tungstate that dissolves in the electrolyte solution 5, and a cobalt compound including cobalt oxide is formed and precipitates from the electrolyte solution 5. In such case, the method may further include, before the step of lowering the pH value of the electrolyte solution 5 (i.e., step 23), a step of collecting the cobalt compound from the electrolyte solution 5. The collecting step may be conducted through at least one of a filtration process, a centrifugation process, an evaporation process, a size-exclusion chromatography process, and combinations thereof.

The present disclosure will be further described by way of the following examples. However, it should be understood that the following examples are intended solely for the purpose of illustration and should not be construed as limiting the present disclosure in practice.

### EXAMPLES AND COMPARATIVE EXAMPLES

In the following methods of Examples 1 to 8 and Comparative Examples 1 and 2, cemented tungsten carbide or tungsten lanthanum alloy served as an anode, and an electrolysis process was performed using different electrolyte solutions having different pH values to recover metals from the anode.

### Example 1 (EX1)

Hydrochloric acid was dissolved in water to form an aqueous hydrochloric acid solution (HCl) which serves as an electrolyte solution and which has a concentration of 1 M and a pH value of 0, and then a rod-shaped cemented tungsten carbide (including tungsten and cobalt) (Source: Yih Dyen Hardware Co., Ltd.) serving as an anode and a rod-shaped tungsten (Source: Abicor Binzel) serving as a cathode were immersed in the aqueous hydrochloric acid solution. Next, the cemented tungsten carbide was subjected to an electrolysis process under a power density of 3.5 W/cm² on the anode for 10 minutes, so that a metal oxide layer (i.e., passivation layer) formed on a surface of the cemented tungsten carbide during the electrolysis process was broken down and dispersed in the aqueous hydrochloric acid solution and the cemented tungsten carbide is exposed and permitted to be dissolved and oxidized, thereby obtaining (i) tungsten oxide in a hydrated form (WO₃·nH₂O) that precipitated from the aqueous hydrochloric acid solution and then was collected by a filtration process; and (ii) cobalt ions which dissolved in the aqueous hydrochloric acid solution and were then partially reduced to cobalt element that was electrodeposited onto the cathode.

Thereafter, the tungsten oxide thus collected and cobalt element electrodeposited on the cathode were subjected to determination of purity by energy dispersive X-ray spectroscopy (EDX).

In addition, the dissolution rate of the anode (i.e., cemented tungsten carbide) was determined by dividing the difference in weight of the anode before and after the electrolysis process with the time period for performing the electrolysis process.

### Examples 2 to 4 (EX2 to EX4)

The methods of EX2, EX3 and EX4 were similar in procedures to those conducted in EX1, except that, the power density applied on the anode (i.e., cemented tungsten carbide) in E2 to E4 were 13.8 W/cm², 27.6 W/cm², and 34.5 W/cm², respectively.

### Example 5 (EX5)

The method of EX5 was similar in procedures to those conducted in EX1, except that, in EX5, tungsten lanthanum alloy served as the anode, and the power density applied on the anode was 34.5 W/cm². In addition, during the electrolysis process, lanthanum ions dissolved in the aqueous hydrochloric acid solution and were then partially reduced to lanthanum element that was electrodeposited onto the cathode. The purity of the lanthanum element electrodeposited on the cathode was also determined using EDX.

### Example 6 (EX6)

The method of EX6 was similar in procedures to those conducted in EX1, except that, in EX6, the electrolyte solution was an aqueous sulfuric acid solution (H₂SO₄) which had a concentration of 1 M and a pH value of 0, and which was prepared by dissolving sulfuric acid in water.

### Example 7 (EX7)

The method of EX7 was similar in procedures to those conducted in EX1, except that, in EX7, the electrolyte solution was an aqueous sodium chloride solution (NaCl) which had a concentration of 1 M and a pH value of 7 and which was prepared by dissolving sodium chloride in water, and the power density applied on the anode (i.e., cemented tungsten carbide) was 6.9 W/cm².

### Example 8 (EX8)

The method of EX8 was similar in procedures to those conducted in EX1, except that, in EX8, the electrolyte solution was an aqueous sodium carbonate solution (Na₂CO₃) having a concentration of 1 M and a pH value of 12, and the power density applied on the anode (i.e., cemented tungsten carbide) was 6.9 W/cm². In addition, during the electrolysis process, tungstate (WO₄²⁻) was formed and dissolved in the aqueous sodium carbonate solution, and a cobalt compound including cobalt oxide (CoO) and/or cobalt (II) hydroxide (Co(OH)₂) was formed and precipitated from the aqueous sodium carbonate solution.

After the cobalt compound was collected by the filtration process from the aqueous sodium carbonate solution, an acidic electrolyte substance (e.g., hydrochloric acid or sulfuric acid) was added into the aqueous sodium carbonate solution such that the tungstate was reacted in an acidic aqueous solution to form tungsten oxide in a hydrated form (i.e., tungstic acid). Then, the cobalt compound and the tungstic acid were subjected to determination of purity by EDX.

### Comparative Examples 1 and 2 (CE1 and CE2)

The methods of CE1 and CE2 were similar in procedures to those conducted in EX1, except that, in CE1, no electrical power is applied to the anode (i.e., the power density was 0 W/cm²), and in CE2, the power density applied on the anode (i.e., cemented tungsten carbide) was 1.7 W/cm². No precipitate was observed in CE1 or CE2 after 10 minutes of the electrolysis process.

For clarity, for each of methods of E1 to E8 and CE1 to CE2, the electrolyte solution (including pH value and concentration), the power density and dissolution rate of the anode during the electrolysis process, and the products (including purity) thus formed are summarized and shown in Table 1 below.

TABLE 1

| Method | Electrolyte solution | Electrolysis process | | | Product (purity %) |
|---|---|---|---|---|---|
| | Electrolyte substance (Concentration, pH value) | Anode | Power density (W/cm²) | Dissolution rate (mg/min) | |
| EX1 | HCl (1 M, pH 0) | Cemented tungsten carbide | 3.5 | 26.7 | Hydrated form of tungsten oxide (98.35%); cobalt |
| EX2 | HCl (1 M, pH 0) | Cemented tungsten carbide | 13.8 | 57.8 | Hydrated form of tungsten oxide (99.32%); cobalt |
| EX3 | HCl (1 M, pH 0) | Cemented tungsten carbide | 27.6 | 110.9 | Hydrated form of tungsten oxide (>99.99%); cobalt |
| EX4 | HCl (1 M, pH 0) | Cemented tungsten carbide | 34.5 | 147.5 | Hydrated form of tungsten oxide (>99.99%); cobalt |
| EX5 | HCl (1 M, pH 0) | Tungsten lanthanum alloy | 34.5 | 35.2 | Hydrated form of tungsten oxide (>99.99%); lanthanum |
| EX6 | H₂SO₄ (1 M, pH 0) | Cemented tungsten carbide | 3.5 | 16.0 | Hydrated form of tungsten oxide (>99.36%); cobalt |
| EX7 | NaCl (1 M, pH 7) | Cemented tungsten carbide | 6.9 | 22.6 | Hydrated form of tungsten oxide (>94.32%); cobalt |
| EX8 | Na₂CO₃ (1 M, pH 12) | Cemented tungsten carbide | 6.9 | 13.8 | Tungstate; cobalt oxide and/or cobalt (II) hydroxide (93.06%) |
| CE1 | HCl (1 M, pH 0) | Cemented tungsten carbide | 0 | 0.2 | No precipitate |
| CE2 | HCl (1 M, pH 0) | Cemented tungsten carbide | 1.7 | 4.2 | No precipitate |

It can be seen from Table 1 that, when the electrolysis process was conducted under a power density that was not greater than 3 W/cm² (i.e., 0 W/cm² for CE1 and 1.7 W/cm² for CE2), the dissolution rate of the anode 4 was less than 5 mg/min, and metal recovery was poor. On the contrary, in each of the methods of EX1 to EX8, when the electrolysis process was conducted under a power density that was greater 3 W/cm² on the anode 4, the anode 4 had a dissolution rate of greater than 13 mg/mL, regardless of the pH value of the electrolyte solution being 7 (neutral), not greater than 2 (acidic) or not less than 10 (alkaline). When the power density on the anode 4 was increased to near 35 W/cm², as shown by EX4, the dissolution rate of the anode 4 can be achieved up to 147.5 mg/min. These results indicate that the dissolution of anode during the electrolysis process was not adversely affected by formation of a passivation layer thereon as observed in conventional methods for recovering metals from tungsten-containing metallic materials. In addition, as shown by the methods of EX1 to EX8, the oxidation state of tungsten and other metals (e.g., cobalt and lanthanum) which are released from the tungsten-containing metallic materials (serving as the anode 4) can be altered by adjusting the pH value of the electrolyte solution 5, such that these metals dissolved in or precipitated from the electrolyte solution 5 depending on their oxidation states, and thus, such metals recovered from the tungsten-containing metallic materials and cobalt/lanthanum are easily separated and collected by, e.g., the filtration process.

In addition, as shown in Table 1, the tungsten oxide in the hydrated form obtained in a respective one of the methods of EX1 to EX7 had a purity of greater than 90%, and when the power density was increased to 27 W/cm², the dissolution rate of the cemented tungsten carbide (serving as the anode 4) was greater than 110 mg/min and the purity of the thus obtained tungsten oxide in the hydrated form can even reach as high as 99.99%, i.e., a purity level of 4N (see EX3 and EX4), demonstrating that the electrolysis process can be efficiently conducted in a short time period (i.e., a high reaction rate) and metals can be effectively recovered from the tungsten-containing metallic material.

In summary, in the method for recovering metals from the tungsten-containing metallic material of the present disclosure, by controlling the power density on the anode 4 (i.e., the tungsten-containing metallic material) to be greater than 3 W/cm² during the electrolysis process, the passivation layer (i.e., the metal oxide layer) formed on the surface of the anode 4 during the electrolysis process can be broken down and fall off from the anode 4, so as to permit the anode 4 to be continuously dissolved and oxidized, thereby improving dissolution rate of the anode 4 so as to obtain tungsten-containing compound with high purity. Moreover, since the oxidation state of tungsten can be altered by adjusting the pH value of the electrolyte solution 5, the tungsten-containing compound formed in the electrolyte solution 5 during the electrolysis process is tungstate that dissolves in the electrolyte solution 5, or tungsten oxide (e.g., tungsten oxide in a hydrated form and tungsten trioxide hydrates) that precipitates from the electrolyte solution 5, and such tungsten-containing compound can be easily obtained by the filtration process.

In the description above, for the purposes of explanation, numerous specific details have been set forth in order to provide a thorough understanding of the embodiments. It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects, and that one or more features or specific details from one embodiment may be practiced together with one or more features or specific details from another embodiment, where appropriate, in the practice of the disclosure.

While the disclosure has been described in connection with what are considered the exemplary embodiments, it is understood that this disclosure is not limited to the disclosed embodiments but is intended to cover various arrangements included within the spirit and scope of the broadest interpretation so as to encompass all such modifications and equivalent arrangements.

What is claimed is:

1. A method for recovering metals from tungsten-containing metallic material, comprising the steps of:
providing a cathode and the tungsten-containing metallic material serving as an anode in an electrolyte solution which has a pH value of one of neutral, not greater than 2, and not less than 10; and
subjecting the tungsten-containing metallic material to an electrolysis process under a power density that is greater than 3 W/cm² on the anode so that a passivation layer formed on the anode during the electrolysis process is broken down to permit the tungsten-containing metallic material to be continuously dissolved and oxidized, and a tungsten-containing compound is formed in the electrolyte solution.

2. The method as claimed in claim 1, wherein the anode is dissolved in a dissolution rate of not less than 13 mg/min during the electrolysis process.

3. The method as claimed in claim 1, wherein the pH value of the electrolyte solution in the providing step is one of neutral and not greater than 2, and the tungsten-containing compound formed during the electrolysis process includes tungsten oxide that precipitates from the electrolyte solution.

4. The method as claimed in claim 1, wherein the pH value of the electrolyte solution in the providing step is not less than 10, and the tungsten-containing compound formed during the electrolysis process includes tungstate that dissolves in the electrolyte solution.

5. The method as claimed in claim 4, further comprising, after the electrolysis process, the step of lowering the pH of the electrolyte solution to convert tungstate to tungsten oxide that precipitates from the electrolyte solution.

6. The method as claimed in claim 5, wherein the step of lowering the pH of the electrolyte solution is conducted by adding an acidic electrolyte substance.

7. The method as claimed in claim 1, wherein the electrolysis process is conducted under the power density ranging from 3 W/cm² to 35 W/cm² on the anode.

8. The method as claimed in claim 1, wherein the electrolyte solution having the pH value of not greater than 2 is prepared using an inorganic acid selected from the group consisting of hydrochloric acid, sulfuric acid, nitric acid, perchloric acid, and combinations thereof.

9. The method as claimed in claim 1, wherein the electrolyte solution having the pH value of 7 is prepared using a neutral electrolyte selected from the group consisting of sodium chloride, potassium chloride, potassium sulfate, and combinations thereof.

10. The method as claimed in claim 1, wherein the electrolyte solution having the pH value of not lower than 10 is prepared using an inorganic base selected from the group consisting of sodium carbonate, potassium carbonate, potassium hydroxide, and combinations thereof.

11. The method as claimed in claim 1, wherein the tungsten-containing metallic material is selected from the group consisting of cemented tungsten carbide, tungsten lanthanum alloy, a doped tungsten, and combinations thereof.

12. The method as claimed in claim 3, wherein the tungsten-containing metallic material is cemented tungsten carbide including tungsten and cobalt, the anode is dissolved during the electrolysis process in a dissolution rate of not less than 15 mg/min to produce tungsten oxide in a hydrated form having a purity of not lower than 90%, and cobalt is electrodeposited onto the cathode.

13. The method as claimed in claim 5, wherein the tungsten-containing metallic material is cemented tungsten carbide including tungsten and cobalt, and during the electrolysis process, a cobalt compound is formed and precipitates from the electrolyte solution, the cobalt compound including one of cobalt oxide, cobalt hydroxide, and a combination thereof.

14. The method as claimed in claim 13, wherein the method further comprises, before the step of lowering the pH of the electrolyte solution, the step of collecting the cobalt compound from the electrolyte solution.

15. The method as claimed in claim 14, wherein the collecting step is performed through one of a filtration process, a centrifugation process, an evaporation process, a size-exclusion chromatography process, and combinations thereof.

16. The method as claimed in claim 1, wherein the electrolysis process is conducted at a temperature ranging from 60° C. to 80° C.
